(19) United States
(12) Patent Application Publication
(10) Pub. No.: US 2021/0075356 A1
(43) Pub. Date: Mar. 11, 2021

(54) MOTOR CONTROL APPARATUS AND CONTROL METHOD THEREOF

(71) Applicant: CANON KABUSHIKI KAISHA, Tokyo (JP)

(72) Inventor: Hirokazu Takahashi, Tokyo (JP)

(21) Appl. No.: 17/012,333

(22) Filed: Sep. 4, 2020

(30) Foreign Application Priority Data
Sep. 11, 2019 (JP) 2019-165530

(51) Int. Cl. H02P 21/22; H02P 21/18; H02P 21/36

(52) U.S. Cl. CPC H02P 21/22; H02P 21/36; H02P 21/18

(57) ABSTRACT

A motor control apparatus for controlling a motor, comprises: a driving unit configured to drive the motor; a measurement unit configured to measure a current value flowing to a terminal of each phase of the motor; and an abnormality detection unit configured to short the terminal of each phase of the motor during driving of the motor by the driving unit and detect rotation abnormality of the motor based on the current value measured by the measurement unit during a period of the short.

### BACKGROUND OF THE INVENTION

### Field of the Invention

The present invention relates to control of a motor and, more particularly, to detection of rotation abnormality of a motor.

### Description of the Related Art

As a washing machine motor that rotates the drum of a washing/spin drying tub or an electric fan motor that rotates the fan of an electric fani/blower or the like, a 3-phase brushless DC motor is generally used. The 3-phase brushless DC motor includes stators of three phases, that is, a U phase, a V phase, and a W phase. The motor can be rotated by controlling voltages applied to the stators of the three phases. In addition, the rotation speed that changes depending on the rotation load of the motor or the like is detected and fed back to control, thereby implementing a stable rotation speed.

Conventionally, the rotation speed is detected or measured using a sensor such as a Hall sensor in the 3-phase brushless DC motor. In recent years, however, a method (sensorless vector control) of estimating the rotation speed based on a current value concerning the three phases without using the sensor has widely been used.

However, in a case in which a motor is controlled without using a sensor, even if the motor has rotation abnormality, it is impossible to directly detect the abnormality. For example, In Japanese Patent No. 4112265, rotation abnormality is determined based on the estimated value and the command value of an angular frequency. Additionally, in Japanese Patent Laid-Open No. 2001-286197, rotation abnormality is determined based on the sign of the torque component of a current and the sign of effective power.

However, rotation speed estimation performed by the sensorless vector control assumes normal rotation of the motor, and correct estimation cannot be obtained at the time of abnormality. Also, in the method using the estimated speed, rotation abnormality is erroneously detected during a period such as a motor activation time in which speed estimation is not stable.

Additionally, in the detection method using a motor current, the current flowing to the motor at the time of rotation abnormality has a plurality of patterns, and it is difficult to judge these. For example, even if the motor has stopped due to an external factor, a sine wave current may continuously be supplied by motor control, or a DC current may continuously be supplied. In the former case, it may be determined that the motor is normally rotating even if the motor has abnormally stopped.

### SUMMARY OF THE INVENTION

According to one aspect of the present invention, a motor control apparatus for controlling a motor, comprises: a driving unit configured to drive the motor; a measurement unit configured to measure a current value flowing to a terminal of each phase of the motor; and an abnormality detection unit configured to short the terminal of each phase of the motor during driving of the motor by the driving unit and detect rotation abnormality of the motor based on the current value measured by the measurement unit during a period of the short.

The present invention more suitably detects rotation abnormality of a motor.

Further features of the present invention will become apparent from the following description of exemplary embodiments (with reference to the attached drawings).

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a block diagram showing the overall arrangement of a motor control apparatus;

FIG. 2 is a block diagram showing the arrangement of a feedback control unit included in the motor control apparatus;

FIG. 3 is a block diagram showing the arrangement of a driver unit included in the motor control apparatus;

FIG. 4 is a flowchart in a normal driving mode;

FIG. 5 is a flowchart in an abnormality detection mode;

FIGS. 6A and 6B are views for explaining a rotation abnormality judgment method (first embodiment); and

FIGS. 7A and 7B are views for explaining a rotation abnormality judgment method (second embodiment).

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made an invention that requires all such features, and multiple such features may be combined as appropriate. Furthermore, in the attached drawings, the same reference numerals are given to the same or similar configurations, and redundant description thereof is omitted.

### First Embodiment

As a motor control apparatus according to the first embodiment of the present invention, a motor control apparatus 100 that drives a 3-phase brushless DC motor will now be described as an example.

<Apparatus Arrangement>

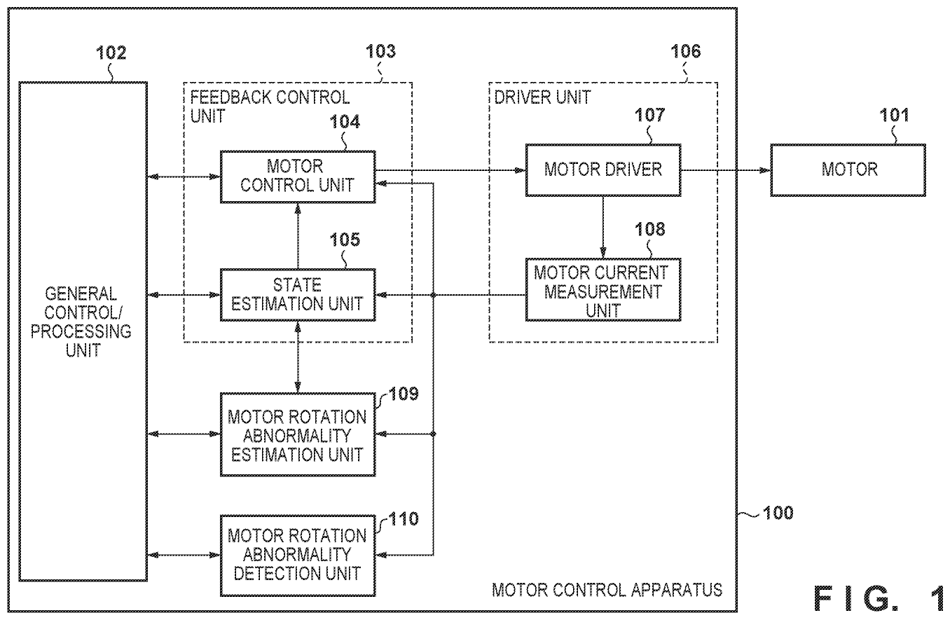

FIG. 1 is a block diagram showing the overall arrangement of the motor control apparatus 100 that controls a motor 101. The motor control apparatus 100 includes a general control/processing unit 102, a feedback control unit 103, a driver unit 106, a motor rotation abnormality estimation unit 109, and a motor rotation abnormality detection unit 110.

The motor 101 is a motor of a driving target, and is, for example, a 3-phase brushless DC motor. The general control/processing unit 102 controls each unit of the motor control apparatus 100.

The feedback control unit 103 calculates/outputs a signal necessary for driving in every predetermined motor control period while estimating the state of the motor. The feedback control unit 103 includes a motor control unit 104 that performs an operation for closed loop control according to a motor speed or a current state, and a state estimation unit 105 that estimates a motor speed or the like. The state estimation unit 105 performs speed estimation by a known arbitrary method and, for example, estimates an induced voltage generated in the motor from motor current information to be described later and performs speed estimation.

The driver unit 106 corresponds to an electric component that drives the motor 101. The driver unit 106 includes a motor driver 107 that performs switching of a voltage based on a command signal from the feedback control unit 103, and a motor current measurement unit 108 that measures a current flowing to the motor 101. The motor driver 107 performs switching of the voltage using, for example, FETs. The motor current measurement unit 108 detects the current flowing to the motor 101 by, for example, a shunt resistor, and after A/D conversion, makes the current usable as current information in each unit of the motor control apparatus 100.

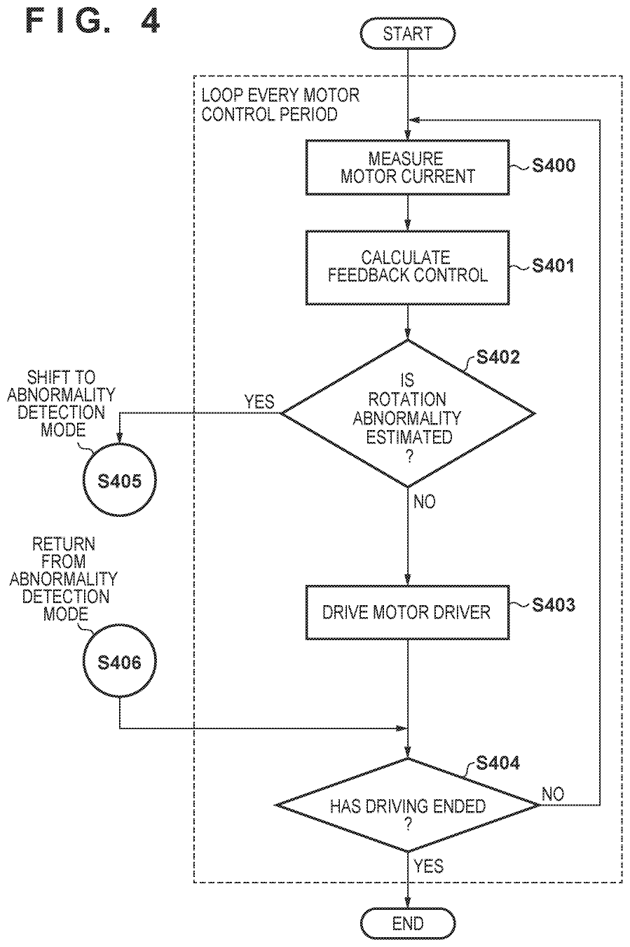

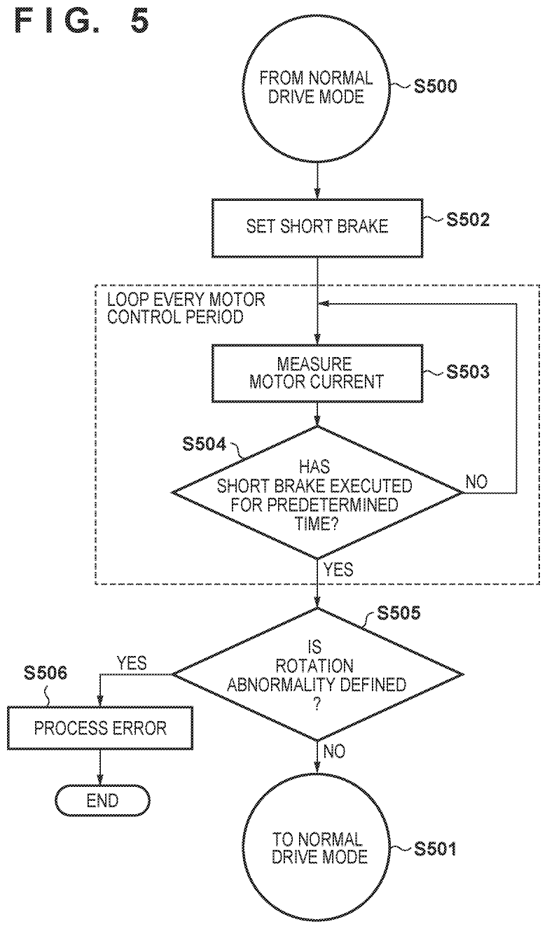

The motor rotation abnormality estimation unit 109 has a function of primarily determining, based on the information of the state estimation unit 105 or the motor current measurement unit 108, whether abnormality in the motor 101 is suspected. Details will be described later with reference to FIG. 4. The motor rotation abnormality detection unit 110 has a function of determining motor rotation abnormality in an abnormality detection mode. Details will be described later with reference to FIG. 5.

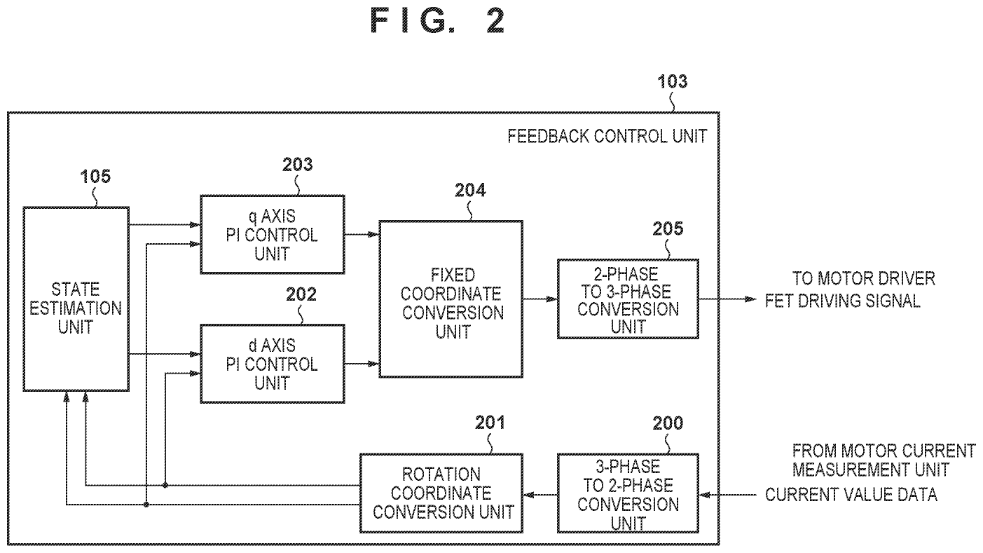

FIG. 2 is a block diagram showing the arrangement of the feedback control unit 103 included in the motor control apparatus 100. A representative method called vector control is applied inside, and an operation is performed in every predetermined motor control period.

A 3-phase to 2-phase conversion unit 200 converts the 3-phase current information of the motor current measurement unit 108 into 2-phase current components that are components orthogonal to each other on the assumption that the 3-phase currents are 3-phase balanced sine waves. A rotation coordinate conversion unit 201 converts the 2-phase currents each operating as a sine wave from a fixed coordinate system to a rotation coordinate system, and converts these into a d-axis current representing a magnetic flux component and a q-axis current representing a torque component.

The state estimation unit 105 performs speed estimation based on motor current information, as described above. A d-axis PI control unit 202 performs a feedback operation according to the difference between a measured d-axis current and a target d-axis current decided by the state estimation unit 105. A q-axis PI control unit 203 performs a feedback operation according to the difference between a measured q-axis current and a target q-axis current decided by the state estimation unit 105.

A fixed coordinate conversion unit 204 converts voltage command values calculated by the d-axis PI control unit 202 and the q-axis PI control unit 203 from the rotation coordinate system to a fixed coordinate system. As for the operation, an operation reverse to that of the rotation coordinate conversion unit 201 is performed. A 2-phase to 3-phase conversion unit 205 converts 2-phase voltages from the fixed coordinate conversion unit 204 into 3-phase voltages on the assumption that these are 3-phase balanced sine waves. As for the operation, an operation reverse to that of the 3-phase to 2-phase conversion unit 200 is performed.

Note that the arrangement of the feedback control unit 103 shown in FIG. 2 is merely an example. For example, the target d-axis current may be fixed to 0 (zero), or another mechanism such as magnetic flux compensation may be added.

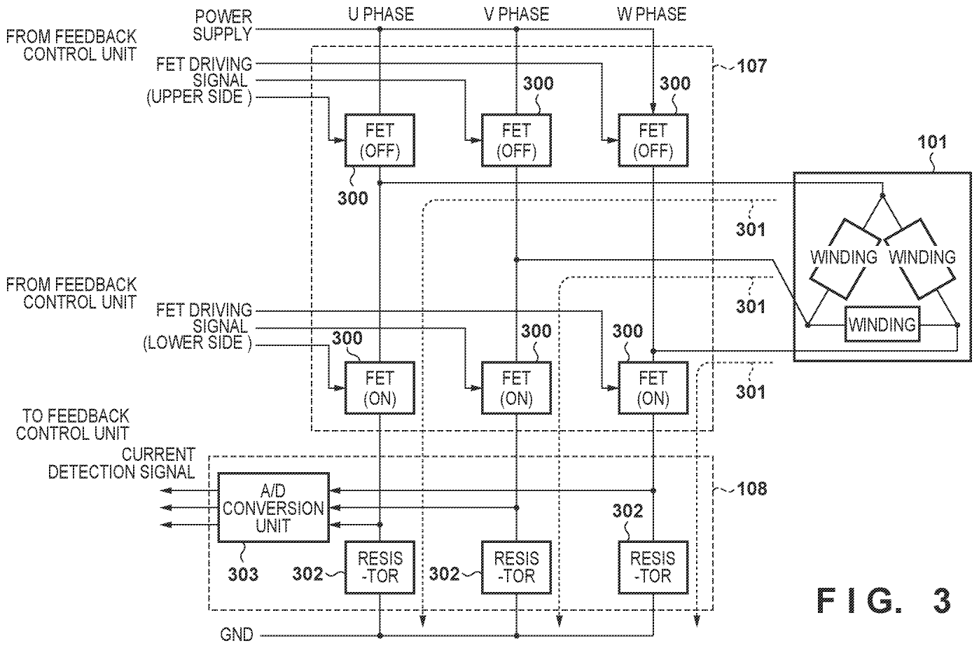

FIG. 3 is a block diagram showing the arrangement of the driver unit 106 included in the motor control apparatus 100. The driver unit 106 includes the motor driver 107 and the motor current measurement unit 108.

As described above, the motor driver 107 supplies power to the motor 101 by switching a power supply. More specifically, a power supply and GND are connected to each of the three phases (a U phase, a V phase, and a W phase) of the motor 101 via FETs 300, and the FETs 300 are controlled based on a signal from the feedback control unit 103, thereby driving the motor 101. Note that in FIG. 3, since the FETs 300 are arranged on the power supply side and on the GND side in each of the three phases, a total of six FETs exist.

Additionally, as described above, the motor current measurement unit 108 detects a motor current 301 and makes it usable as current information in each unit of the motor control apparatus 100, More specifically, a resistor 302 configured to detect the motor current 301 as a voltage is arranged, and the motor current 301 in the resistor 302 is measured at a timing when the FET 300 on the GND side is ON. An A/D conversion unit 303 converts a voltage generated in the resistor 302 into a digital value. An amplifier function of representatively amplifying a voltage is also included.

<Operation of Apparatus>

FIG. 4 is a flowchart of a motor operation in a normal driving mode. Execution instructions and branch judgment in this procedure are performed by the general control/processing unit 102.

In step S400, the general control/processing unit 102 controls the motor current measurement unit 108 to acquire the measurement result of the motor current. In step S401, the general control/processing unit 102 controls the feedback control unit 103 to perform an operation necessary for motor control.

In step S402, the general control/processing unit 102 branches the operation depending on whether state abnormality is estimated by the motor rotation abnormality estimation unit 109. If state abnormality is estimated (YES in step S402), the process advances to step S405 to shift to an abnormality detection mode. If state abnormality is not estimated (NO in step S402), the process advances to step S403 to continue normal driving.

The branch of step S402 corresponds to primary determination of motor rotation abnormality judgment. To determine abnormality estimation, an operation internal value of the feedback control unit 103 is used. For example, determination is performed based on whether the difference between a motor rotation speed (estimated speed) estimated by the state estimation unit 105 and a speed as a target (target speed) exceeds a threshold. Alternatively, differences are accumulated for a predetermined period, and determination is performed based on whether the accumulated value exceeds a threshold. In another example, judgment is performed based on whether a current value obtained from the motor current measurement unit 108 or a value obtained by converting the current value exceeds a threshold, or a value obtained by accumulating current values for a predetermined period exceeds a threshold.

In step S403, the general control/processing unit 102 drives the motor driver 107 based on the operation result by the feedback control unit 103.

In step S404, the general control/processing unit 102 determines whether to end the driving. To end the driving (YES), the processing is ended. Not to end the driving (NO), the process returns to step S400 to continue the processing. The loop of steps S400 to S404 is repeated at a predetermined motor control period.

FIG. 5 is a flowchart of a motor operation in the abnormality detection mode. Execution instructions and branch judgment in this procedure are performed by the general control/processing unit 102.

Step S500 is a node connected to step S405 of FIG. 4. Step S501 is a node connected to step S406 of FIG. 4.

In step S502, the general control/processing unit 102 performs short brake setting of the motor driver 107 via the motor control unit 104. Here, short brake is an operation of shorting each terminal of the motor 101. More specifically, of the FETs 300 in the motor driver 107, the FETs on the power supply side are set to OFF (energization stop), and the FETs on the GND side are set to ON (shorted to GND), thereby implementing short brake.

If the motor 101 is rotating when short brake is performed, a current flows because of the inertia and the inductance component of the motor 101. For this reason, the energy of the motor 101 is consumed as heat by a motor resistor (not shown), the resistors 302 for current detection, and the like. Hence, the presence/absence of the current is detected, thereby performing final judgment of rotation abnormality of the motor.

In step S503, the general control/processing unit 102 acquires the result of the motor current measurement unit 108 via the state estimation unit 105. The acquired current value is used for final judgment of rotation abnormality of the motor.

In step S504, the general control/processing unit 102 determines whether short brake is performed for a predetermined time, and the motor current is measured. If short brake is performed for a predetermined time (YES), the process advances to step S505. If short brake is not performed for a predetermined time (NO), the process returns to step S503 to repeat the loop (steps S503 and S504) at a predetermined motor control period.

In step S505, the general control/processing unit 102 controls the motor rotation abnormality detection unit 110 to perform final judgment of motor rotation abnormality. The motor rotation abnormality detection unit 110 performs final judgment of motor rotation abnormality based on the information of the motor current 301 at the time of short brake, which is measured in step S503. Upon detecting motor rotation abnormality (YES), the process advances to step S506 to shift the whole motor control apparatus 100 to error processing. If motor rotation abnormality is not detected (NO), the process advances to step S501 to return to the normal driving mode and continues motor rotation control.

In step S506, the general control/processing unit 102 executes error processing. The contents of error processing are arbitrary, and include, for example, reactivation of the entire motor control apparatus 100, emergency stop of the motor control apparatus 100, and recording of error information in an external or internal memory (not shown) accessible from the motor control apparatus 100.

<Details of Rotation Abnormality Determination>

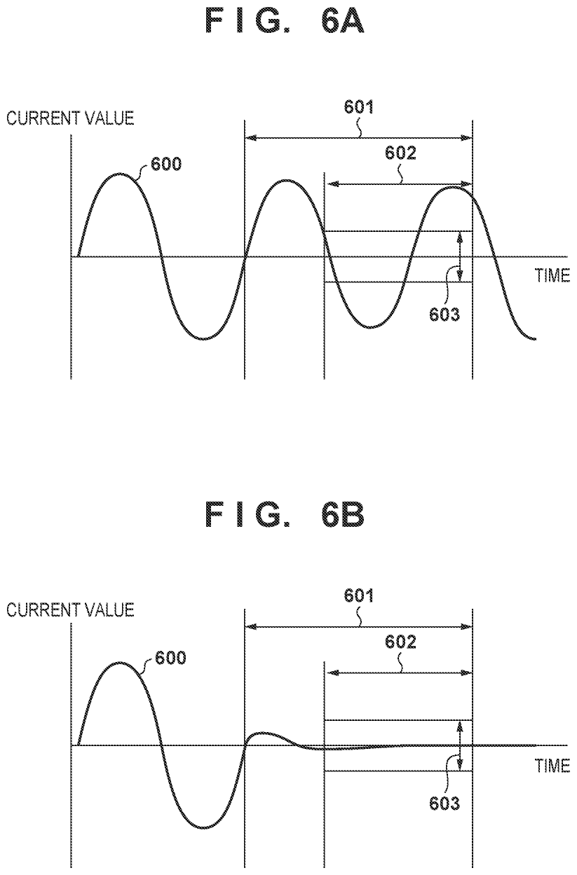

FIGS. 6A and 6B are views for explaining a rotation abnormality judgment method according to the first embodiment. That is. FIGS. 6A and 6B are views for explaining judgment executed by the motor rotation abnormality detection unit 110 in step S505 of FIG. 5. FIG. 6A shows an example of a time-rate change in the current value in a case in which the motor 101 is normally driven. On the other hand, FIG. 6B shows an example of a time-rate change in the current value in a case in which the motor 101 has made an abnormal stop. Note that FIG. 6B shows a state in which a current waveform 600 maintains a sine wave during a period preceding to a short brake setting period 601. However, the current waveform when rotation abnormality has occurred is not necessarily a sine wave.

The current waveform 600 is, for example, the waveform of the current of one phase (for example, the U phase) of the currents of three phases (the U phase, the V phase, and the W phase) flowing to the motor 101. The shortbrake setting period 601 is a period corresponding to the loop (steps S503 and S504) in FIG. 5. A rotation abnormality judgment period 602 and a rotation abnormality judgment range 603 (set within the short brake setting period 601) respectively define current value ranges in the time direction and the amplitude direction used to determine whether rotation abnormality exists.

For example, if the U phase current 600 falls within the rotation abnormality judgment range 603 in the rotation abnormality judgment period 602, it is judged as rotation abnormality. Otherwise, it is judged as normal. This is because if the motor 101 stops, a current derived from the motor inertia is not generated, and the amplitude of the U phase current 600 converges. On the other hand, if the motor 101 is rotating, a current flows because of the inertia and the inductance component of the motor 101 even during the short brake setting period 601. For this reason, the U phase current 600 is maintained to some extent even during the short brake setting period 601.

Note that if the rotation abnormality judgment period 602 is set too short in the short brake setting period 601, the change in the U phase current may fall within the rotation abnormality judgment range 603 even if the motor is rotating. Hence, the rotation abnormality judgment period 602 is preferably set long to some extent (for example, equal to or more than a time corresponding to ½ of the sine wave period in normal rotation). In addition, the rotation abnormality judgment range 603 is preferably set to be, for example, equal to or less than an amplitude corresponding to ⅓ of the sine wave amplitude in normal rotation.

If it is judged that the rotation of the motor is normal, normal driving is resumed after the end of the short brake setting period 601. At this time, to compensate for the change in the motor operation in the short brake setting period 601, additional control of changing or updating information (internal parameter) managed in the feedback control unit 103 may be performed. For example, the estimated position information (an angle, an accumulated value, or the like) of the motor 101 may be corrected in accordance with the rotation abnormality judgment period 602. Also, to quickly return the speed or current that has lowered in the short brake setting period 601 to the normal state, gain setting of feedback control may be changed.

As described above, according to the first embodiment, the motor control apparatus 100 inserts a short brake operation during driving of the motor 101. Then, the rotation abnormality state of the motor 101 is determined with focus placed on the time-rate change in one of the currents of three phases (the U phase, the V phase, and the W phase) in the short brake operation period (short brake setting period 601). With this arrangement, even in a motor driven by sensorless vector control, rotation abnormality of the motor can accurately be detected.

Note that in the above description, after primary determination of motor rotation abnormality judgment by the motor rotation abnormality estimation unit 109 is performed, final judgment by short brake by the motor rotation abnormality detection unit 110 is performed. However, an arrangement that does not perform the primary determination may be employed. For example, final judgment by short brake may be performed when instructed by the user, or final judgment by short brake may periodically be performed.

### Second Embodiment

In the second embodiment, another form in final judgment of rotation abnormality of a motor will be described. More specifically, the rotation abnormality state of a motor 101 is determined with focus placed on time-rate changes in two of currents of three phases (a U phase, a V phase, and a W phase) in a short brake operation period (short brake setting period 601). Note that the apparatus arrangement and operation are the same as in the first embodiment (FIGS. 1 to 5), and a description thereof will be omitted.

<Details of Rotation Abnormality Determination>

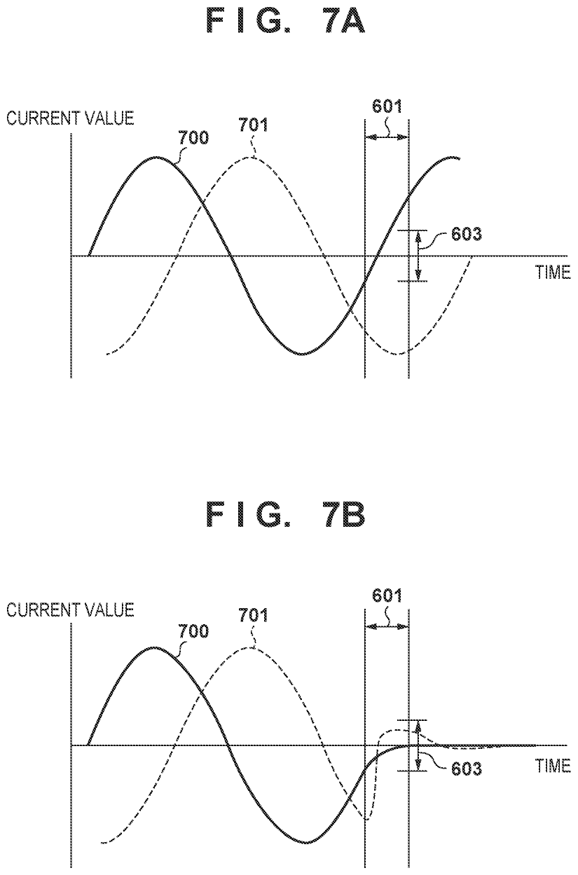

FIGS. 7A and 7B are views for explaining a rotation abnormality judgment method according to the second embodiment. That is, FIGS. 7A and 7B are views for explaining judgment executed by a motor rotation abnormality detection unit 110 in step S505 of FIG. 5. FIG. 7A shows an example of time-rate changes in the current values in a case in which the motor 101 is normally driven. On the other hand, FIG. 7B shows an example of time-rate changes in the current values in a case in which the motor 101 has made an abnormal stop.

Current waveforms 700 and 701 are, for example, the waveforms of the currents of two phases (for example, the U phase and the V phase) of the currents of three phases (the U phase, the V phase, and the W phase) flowing to the motor 101. The short brake setting period 601 is a period corresponding to the loop (steps S503 and S504) in FIG. 5. A rotation abnormality judgment range 603 defines a range in the amplitude direction used to determine whether rotation abnormality exists.

That is, in the second embodiment, the rotation abnormality judgment period 602 in the first embodiment is not used. In the second embodiment, final judgment of rotation abnormality is performed based on whether the current waveform 700 of the U phase and the current waveform 701 of the V phase at the end timing of the short brake setting period 601 fall within the rotation abnormality judgment range 603. More specifically, if both the U phase and the V phase fall within the rotation abnormality judgment range 603, it is judged as rotation abnormality. Otherwise, it is judged as normal. That is, by performing determination for the currents of two phases on the assumption that the currents of three phases (the U phase, the V phase, and the W phase) are 3-phase balanced sine wave currents, it can be determined whether current convergence due to rotation abnormality has occurred.

For this reason, in the second embodiment, the rotation abnormality judgment period 602 in the first embodiment is unnecessary, and the short brake setting period 601 can also be set short as compared to the first embodiment. However, the rotation abnormality judgment range 603 is adjusted and set such that when the motor is normally rotating, one of the U phase current and the V phase current falls within the range, and the other falls outside the range.

As described above, according to the second embodiment, a motor control apparatus 100 inserts a short brake operation during driving of the motor 101. Then, the rotation abnormality state of the motor 101 is determined with focus placed on the current values of two phases at the end of the short brake operation period (short brake setting period 601). With this arrangement, even in a motor driven by sensorless vector control, rotation abnormality of the motor can accurately be detected.

(Modification)

In addition to executing insertion of the short brake operation during normal driving, as described above, insertion of the short brake operation may be executed during deceleration that is a stop sequence to transit from normal driving to a stop state. In this case, permission of next activation may be judged (that is, next activation is prohibited in a case of rotation abnormality), or the user may be notified of fault determination in accordance with the result of determining whether the motor 101 is normally rotating, or rotation abnormality has occurred. In addition, even if the determination result indicates normal rotation, short brake may be performed again to stop the motor because the rotation need not be continued after that.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2019-165530, filed Sep. 11, 2019 which is hereby incorporated by reference herein in its entirety.

What is claimed is:

1. A motor control apparatus for controlling a motor, comprising:
a driving unit configured to drive the motor;
a measurement unit configured to measure a current value flowing to a terminal of each phase of the motor; and
an abnormality detection unit configured to short the terminal of each phase of the motor during driving of the motor by the driving unit and detect rotation abnormality of the motor based on the current value measured by the measurement unit during a period of the short.

2. The apparatus according to claim 1, wherein if a current value of a terminal of one phase measured by the measurement unit falls within a predetermined current value range in a predetermined period in the period of the short, the abnormality detection unit determines that the rotation abnormality has occurred in the motor.

3. The apparatus according to claim 1, wherein if both current values of terminals of two different phases measured by the measurement unit fall within a predetermined current value range at an end of the period of the short, the abnormality detection unit determines that the rotation abnormality has occurred in the motor.

4. The apparatus according to claim 1, further comprising:
a state estimation unit configured to estimate a state of the motor in accordance with the current value measured by the measurement unit; and
a control unit configured to perform control of the motor at a predetermined period in accordance with the state of the motor estimated by the state estimation unit,
wherein if state abnormality is estimated by the state estimation unit, the control unit instructs the abnormality detection unit to short the terminal of each phase of the motor.

5. The apparatus according to claim 4, wherein the state estimation unit estimates a speed of the motor, and estimates the state abnormality if a difference between the estimated speed and a target speed exceeds a first threshold, or if an accumulated value obtained by accumulating the difference for a predetermined period exceeds a second threshold.

6. The apparatus according to claim 4, wherein in a case in which the short is performed during normal driving of the motor by the driving unit, if the abnormality detection unit detects the rotation abnormality, the control unit controls to perform predetermined error processing, and if the abnormality detection unit does not detect the rotation abnormality, the control unit controls to return to the normal driving.

7. The apparatus according to claim 6, wherein the predetermined error processing includes at least one of reactivation of the motor control apparatus, emergency stop of the motor control apparatus, and recording of error information in a memory accessible from the motor control apparatus.

8. The apparatus according to claim 7, wherein when returning the normal driving, the control unit performs additional control of compensating for a change in a motor operation caused by the short.

9. The apparatus according to claim 8, wherein the additional control includes adjusting an internal parameter of the state estimation unit according to a period when the short is performed.

10. The apparatus according to claim 4, wherein in a case in which the short is performed during a time in which the driving unit makes the motor transit from normal driving to a stop state, if the abnormality detection unit detects the rotation abnormality, the control unit controls to perform predetermined error processing, and if the abnormality detection unit does not detect the rotation abnormality, the control unit controls to make the motor transit to the stop state by performing the short again.

11. The apparatus according to claim 10, wherein the predetermined error processing includes prohibition of next activation of the motor control apparatus.

12. A control method of a motor control apparatus for controlling a motor,
the motor control apparatus including a driving unit configured to drive the motor, and a measurement unit configured to measure a current value flowing to a terminal of each phase of the motor,
the control method comprising:
shorting the terminal of each phase of the motor during driving of the motor by the driving unit and detecting rotation abnormality of the motor based on the current value measured by the measurement unit during a period of the short.

13. A non-transitory computer-readable recording medium storing a program that causes a computer to function as a motor control apparatus for controlling a motor, the motor control apparatus comprises:
a driving unit configured to drive the motor;
a measurement unit configured to measure a current value flowing to a terminal of each phase of the motor; and
an abnormality detection unit configured to short the terminal of each phase of the motor during driving of the motor by the driving unit and detect rotation abnormality of the motor based on the current value measured by the measurement unit during a period of the short.
